(19) United States
(12) Patent Application Publication
(10) Pub. No.: US 2007/0024897 A1
(43) Pub. Date: Feb. 1, 2007

(54) Printer directed image decompression

(75) Inventors: Lee Coy Moore, Rochester, NY (US); Phillip J. Emmett, Rochester, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 11/195,194

(22) Filed: Aug. 1, 2005

(51) Int. Cl. G06F 3/12

(52) U.S. Cl. 358/1.15

(57) ABSTRACT

Descriptions can describe or contain document contents and layout. Some contents can be images and, instead of being included as image data in the description, can be image references. An image reference can be used to obtain an image, in the form of image data, from an image server. A printer can print the document after obtaining needed images from image servers. The image data often contains an image whose resolution does not match the resolution that the printer can properly print in the document. The image server can prepare image data with the correct resolution or can stream image data through a data connection to the printer in a hierarchical image format. A printer can receive a stream of hierarchically formatted image data until a desired resolution is reached and then simply close the data connection to cut off the stream of image data.

### TECHNICAL FIELD

Embodiments are generally related to printing methods and systems. Embodiments are also related to imaging data. Embodiments are additionally related to hierarchical image data compression techniques and data streams for efficiently accessing image data for printing.

### BACKGROUND OF THE INVENTION

In the modern workplace, printers can be used to print single copies of a document or millions of copies of a document. Before printing any copies of a document, a printer often receives a print job via a communications network. In many instances, the print job includes a description that is expressed in a page description language. The description typically contains the text and images that should be printed as well as the page layout for positioning the text and images. In other instances, the print job can be an image or series of images in an imaging format such as TIFF or JPEG. The images can contain both text and graphics.

A printer can be a single device, such as one of the commonly available desk top printers, or can be a multiple device system, such as a commercial printing solution. Commercial printing solutions can contain digital front ends, preprocessors, and marking engines. A marking engine is the device that actually prints onto a substrate such as paper. A digital front end can accept print jobs, prioritize them, and process them into the format required by the marking engine. A preprocessor can also accept jobs and process them, but performs processing that the digital front end cannot or should not.

A digital image can be contained in a description. A digital image, such as those images that can be displayed on a computer monitor or are taken with a digital camera, is made of pixels. A pixel is a single spot of color. White, black and grey are considered colors. Most images are rectangular or square. For example, an 800×600 image is 800 pixels wide and 600 pixels high. The width and height of a digital image is the image's resolution.

Printers also have a resolution, but it is measured in dots per inch (dpi) or a similar measure. For example, a 100 dpi image can print 100 dots of ink or toner in one inch. A printer that prints 100 dpi in both the height direction and the width direction can print an 800×600 pixel image as an 8 inch by 6 inch rectangle.

A description containing an image has defined space where that image is to be printed. For example, the description for a document can specify that an image is to be printed in a 2 inch by 2 inch square in the upper left corner of the document. A printer with 100 dpi resolution can print a 200×200 pixel image in a 2 inch by 2 inch square. A printer with 200 dpi resolution can print a 400×400 pixel image in the same square. A printer with 400 dpi resolution can print a 800×800 pixel image in the 2 inch by 2 inch square.

If the description contains image data for a 400×400 pixel image to be printed in the 2 inch by 2 inch square, then only the 200 dpi printer can print the image at its natural resolution. The 100 dpi printer must print a lower resolution version. The 400 dpi printer must print a higher resolution version. Those skilled in the arts of image processing and printing know many techniques for adapting the resolution of an image to match the resolution of a printer and the space in which to print the image.

Users often produce descriptions that can be used by a variety of different printers. The advantage is that the same description can be used without change by all the printers. Therefore, slightly different descriptions of the same document, but for different printers, need not be created. A problem that is thereby avoided is that a description intended for one printer is not accidentally submitted to a different printer.

Producing a single description for every printer also introduces problems. One problem with a one size fits all solution in the digital realm is that the size that fits all is usually the biggest size. Some printers can print in full color and others can only print low resolution black dots on a white background. A description containing image data for a full color copy is wasted on the lesser printer. Transmitting the description can be costly and the printer can be slow to process the image before printing.

An image can be transmitted in the form of image data. Image data must be in a known format in order for it to be used to form an image. Known formats include GIF, PNG, TIFF, and JPEG (also known as JPG). These formats are known to those skilled in the art of desk top publishing. There are also other formats that are known by those skilled in the arts of image transmission, image compression, and printing. Some of those formats are hierarchical image formats.

A hierarchical image format is an image format that is, essentially, a series of increasingly higher resolution versions of an image. For example, a data file can contain a 1000×1000 pixel image in a hierarchical data format. The first part of the data file can contain a 125×125 pixel version of the image. The next part of the file can contain data to convert the 125×125 pixel version to a 250×250 pixel version. The next part of the data file can contain data to produce a 500×500 pixel version from the 250×250 pixel version. The last part of the file can contain data for producing the 1000×1000 pixel image from the 500×500 pixel version.

Some hierarchical image formats are also compressed image formats. A compressed image format is an image format that requires less memory than other formats to store the image. Those skilled in the arts of image processing, image compression, or data compression know methods and techniques for compressing image data. Furthermore, they are acquainted with compressed hierarchical image formats such as JPEG 2000 and FlashPix.

Regardless of the image format, users do create different descriptions of a document for different printers. The users are willing to accept the risks and problems associated with printer specific descriptions because they receive greater control and efficiency. Most users, however, do not really know the properties and capabilities of every printer they use. For example, a user might create a description containing a medium resolution image and submit it to a high resolution printer. The inappropriate description results in a document that the user believes to be reflective of printer quality instead of description quality.

A need therefore exists for descriptions that can be used by all printers without sacrificing image quality and without including more image data than a target printer can use. Such a goal can be accomplished by producing descriptions that include image references instead of image data.

### BRIEF SUMMARY OF THE INVENTION

It is an aspect of the embodiments to create a description that includes image references and submitting the description to a printer. The printer parses the description and uses the image references to obtain images. The printer then prints a document that contains the images. The document that the printer produces can contain an image that was not present in the description. As such, the quality of the printed image is not dependent on image data that is either present in or absent from the description.

It is also a feature of certain embodiments that, based on an image reference, the printer can open a data connection to an image server. The image reference refers to an image stored on the image server. The image server can store the image in any format, including a hierarchical format.

It is a further aspect of certain embodiments for the image server to stream image data to the printer in a hierarchical format. Data is usually transmitted as a data stream; meaning one piece of data follows to another. The recipient of a data stream can gather all the data in the stream and then process it or process each piece of data as it is received. The printer receives the image data as a data stream and processes the image data as it is received to produce a resolving image. As such, the resolving image is initially a low resolution version of the image that is refined into higher resolution versions as more image data is received because the streaming image data is a hierarchically formatted image. The image format can be a compressed hierarchical image format such as JPEG 2000 or FlashPix.

It is a yet further aspect of certain embodiments that the printer continues to receive the streaming image data while the resolution of the resolving image is less than a desired resolution. The desired resolution is the resolution at which the printer is intended to print the image. When the resolving image resolution meets or exceeds the desired resolution, the printer closes the data connection because additional image data can not be used.

Images can be stored on the image server in a hierarchical image format or compressed hierarchical image format that can be streamed without modification to a printer. Images can also be stored in other formats. When an image request is received for an image, the image can be converted into a hierarchical image format by a conversion module. Alternatively, the image can be converted to a compressed hierarchical image format by a compression module.

An aspect of alternative embodiments is to include the desired resolution within the image request. The image server then processes the request, produces an image of the desired resolution for the printer and the printer then obtains that image. In this embodiment, the image reference can be a uniform resource locator, such as used for the http and ftp internet protocols, and the image request can be a web page request. The web page request can be based on the image reference and can contain additional information, such as the desired resolution.

### BRIEF DESCRIPTION OF THE DRAWINGS

The particular values and configurations discussed in these non-limiting examples can be varied and are cited merely to illustrate one or more embodiments and are not intended to limit the scope thereof;

FIG. 1 illustrates a high level flow diagram for printing a document based on a description in accordance with an aspect of the embodiments;

FIG. 2 illustrates a high level flow diagram of obtaining an image from an image server in accordance with an aspect of the embodiments;

FIG. 3 illustrates a high level flow diagram of a printer obtaining prepared images from an image server; and

FIG. 4 illustrates a printer printing a document based on a description and containing images obtained from an image server.

### DETAILED DESCRIPTION OF THE INVENTION

The particular values and configurations discussed in these non-limiting examples can be varied and are cited merely to illustrate embodiments and are not intended to limit the scope of the invention.

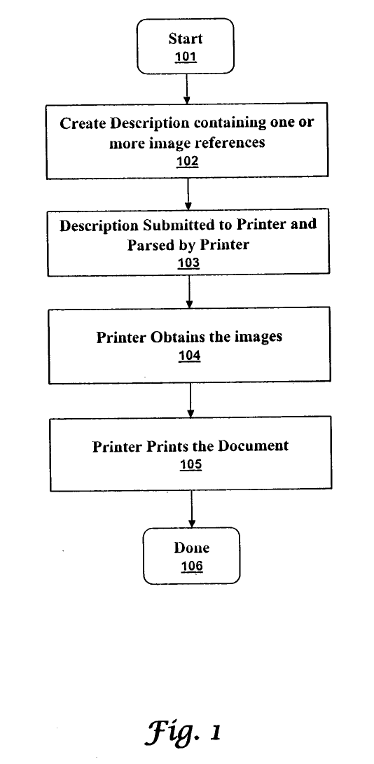

FIG. 1 illustrates a high level flow diagram for printing a document 105 based on a description in accordance with an aspect of the embodiments. After the start 101, a description is created that contains one or more image references 102. An image reference specifies a way to obtain an image from an image server. For example, the image reference can be a uniform resource locator for obtaining the image from a web server. The image reference can also be the name of a file stored on a network file server. The description is submitted to a printer and then parsed by the printer 103. Parsing is a general term used by those skilled in the art of computer programming for reading data and preparing to make use of it. By parsing the description, the printer discovers what image references are contained in the description. Using the image references, the printer obtains the images 104, prints the document 105, and is done 106.

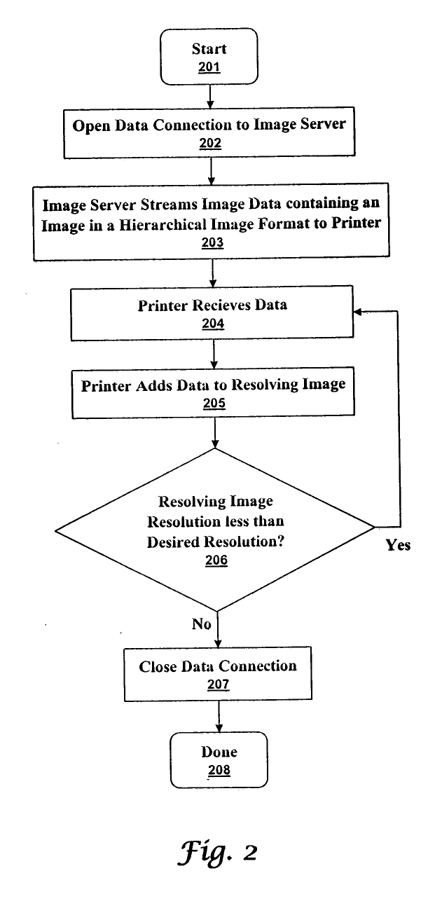

FIG. 2 illustrates a high level flow diagram of obtaining an image from an image server in accordance with an aspect of the embodiments. After the start 201, a data connection is opened to an image server 202. Data connections can be opened in many ways. For example, a TCP/IP connection over the internet can be used. Those skilled in the arts of communications or computer networks know many ways for a client, such as a printer, to open a data connection to a server, such as an image server. A further example is that a data connection can be opened using telephony as when one modem is used to call another. The only requirement for opening a data connection is a first entity using a communications network to contact a second entity.

After the data connection is opened 202, the image server streams image data containing an image in a hierarchical image format to the printer 203. Hierarchical image formats and streaming are discussed above. Recall that streaming means that the data, consisting of many pieces, is sent and received one piece at a time. As the printer receives the data 204 it adds the data to a resolving image 205. In other words, when the printer gets a piece of data, it processes that piece without necessarily waiting for all the pieces of data in the data stream to arrive. If the resolving image's resolution is less than a desired resolution 206, the printer keeps receiving data 204. Otherwise, the printer closes the data connection 207 because it has received as high a resolution version of the image as it wants and is therefore done 208.

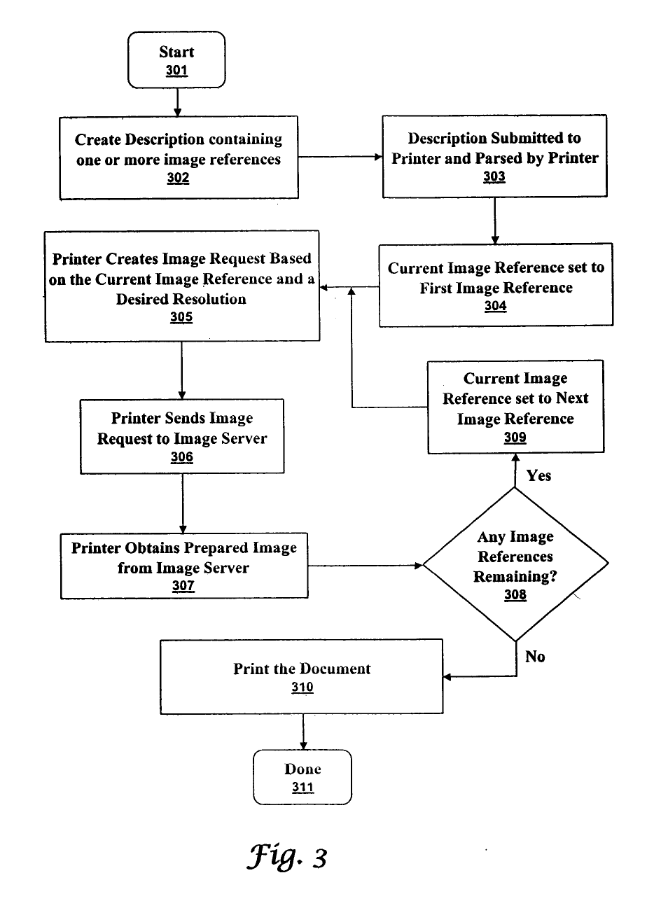

FIG. 3 illustrates a high level flow diagram of a printer obtaining prepared images from an image server. After the start 301, an image description is created 302 and submitted to a printer and parsed 303. Note that many printers are capable of receiving and storing an image description that can be printed at a later time. As such, some printers can perform concurrent operations such as receiving two different image descriptions at the same time while parsing another and printing yet another. Next, the printer sets the current image reference to the first image reference 304. The printer creates an image request based on the current image reference and a desired resolution 305. The desired resolution can be determined based on the printer's resolution and the size at which the image will be printed. The printer then sends the image request to an image server 306 and then receives a prepared image from the image server 307.

Unlike the flow of FIG. 2 where the image server does not need to know the desired resolution, the image server of FIG. 3 must know it. The reason is that the image server creates the prepared image based on the image request and the printer's desired resolution. As above, those skilled in the art of image processing know numerous ways to process an image to obtain a version with a desired resolution.

After obtaining the prepared image 307 the printer checks to see if another image is needed 308. If so, the printer sets the current reference to the next image reference 309 and loops back to creating an image request 305. Otherwise, the printer can print the document 310 and is done 311.

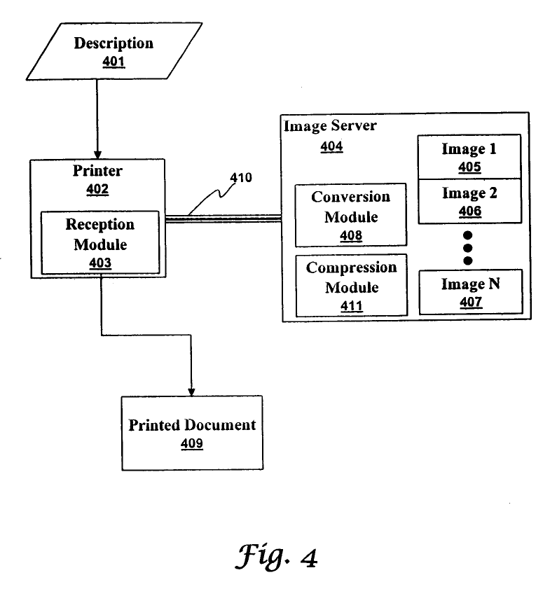

FIG. 4 illustrates a printer 402 producing a printed document 409 based on a description 401 and containing images obtained from an image server 404. As discussed above, the printer 402 can receive a description 401 that contains image references. The printer 402 parses the description 401 and opens a data connection 410 to an image server 404. The printer 402 creates and sends an image request to the image server 404 which responds by streaming image data through the data connection 410 to the printer 402.

The image server 404 stores images. In FIG. 4, the image server stores image 1 405, image 2 406, and so forth to image N 407. As such, the image server 404 stores N images. The images can be stored in any format. Upon receiving an image request, however, the images must be streamed in the proper format. If needed, the image server 404 can use a conversion module 408 to convert an image to a hierarchical image format or a compression module 411 to convert it to a compressed hierarchical format. Regardless of the image being stored in the proper format or converted to the proper format, the image data is streamed through the data connection 410 to the printer.

The printer 402 receives the image data streaming through the data connection 410 and processes it in a reception module 403. The reception module 403 converts the streaming image data into a resolving image, as discussed above. After the printer 402 has obtained all the needed images, it can print the printed document 409.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims:

1. A method comprising:
creating a description wherein the description comprises at least one image reference and submitting the description to a printer;
the printer parsing the description;
the printer obtaining at least one image wherein the at least one image can be obtained using the at least one image reference; and
printing a document that includes the at least one image wherein the document is specified by the description, thereby using a description that does not contain the at least one image to produce a document.

2. The method of claim 1 wherein obtaining each of the at least one image comprises:
the printer opening a data connection based on the at least one image reference to an image server that can store each of the at least one image in a hierarchical image format;
the image server streaming image data to the printer wherein the image data comprises an image in the hierarchical image format;
the printer decompressing the image data as the image data is obtained to produce a resolving image; and
the printer closing the data connection when the resolution of the resolving image equals or exceeds the printers desired resolution for printing the image.

3. The method of claim 2 wherein the hierarchical image format is a hierarchical compressed image format

4. The method of claim 2 wherein the hierarchical image format is the JPEG2000 image format

5. The method of claim 2 wherein the hierarchical image format is the FlashPix image format.

6. The method of claim 1 wherein obtaining each of the at least one image comprises:
the printer opening a data connection based on the at least one image reference to an image server that can convert each of the at least one image into a hierarchical image format;
the image server streaming image data to the printer wherein the image data comprises an image in the hierarchical image format;
the printer decompressing the image data as the image data is obtained to produce a resolving image; and
the printer closing the data connection when the resolution of the resolving image equals or exceeds the printers desired resolution for printing the image.

7. The method of claim 6 wherein the hierarchical image format is a hierarchical compressed image format

8. The method of claim 6 wherein the hierarchical image format is the JPEG2000 image format

9. The method of claim 6 wherein the hierarchical image format is the FlashPix image format.

10. A method comprising:
creating a description wherein the description comprises at least one image reference and submitting the description to a printer;
the printer parsing the description and sending at least one image request to at least one image server wherein each of the at least one request is based on at least one image reference and a desired resolution;
the at least one image server processing the at least one image request to produce at least one prepared image and the printer obtaining the at least one prepared image; and
printing a document that includes the at least one prepared image wherein the document is specified by the description, thereby using a description that does not contain the at least one image to produce a document.

11. The method of claim 10 wherein the at least one image reference is a uniform resource location.

12. The method of claim 10 wherein the at least one image reference comprises a file name and file path for accessing a file over a network file system.

13. The method of claim 10 wherein the prepared image is compressed into a hierarchical image format such as JPEG2000 or FlashPix.

14. A system comprising:
a printer and at least one image server that stores at least one image;
a communications network through which the at least one printer can access the at least one image server;
a description comprising at least one image reference; and
a data stream from the image server to the printer based on the image reference.

15. The system of claim 14 wherein the printer comprises at least one decompression module, the image server can serve any one of the at least one image in a compressed format that the decompression module can decompress, and the data stream comprises image data in the compressed format.

16. The system of claim 15 wherein the compressed format is a hierarchically compressed format.

17. The system of claim 16 wherein the decompression module decompresses the data stream into a resolving image as the data stream is received and cuts the data stream when the resolution of the resolving image meets or exceeds a desired resolution.

18. The system of claim 14 wherein the printer comprises at least one decompression module, the image server comprises at least one compression module that can compress any one of the at least one image into a compressed format that the decompression module can decompress, and the data stream comprises image data in the compressed format.

19. The system of claim 18 wherein the compressed format is a hierarchically compressed format.

20. The system of claim 19 wherein the decompression module decompresses the data stream into a resolved image as the data stream is received and cuts the data stream when the resolution of the resolving image meets or exceeds a desired resolution.
